(19) United States
(12) Patent Application Publication
(10) Pub. No.: US 2015/0203184 A1
(43) Pub. Date: Jul. 23, 2015

(54) SAIL-EQUIPPED AMPHIBIOUS AEROSTAT OR DIRIGIBLE

(71) Applicant: JOSEPH NILO SARMIENTO, VANCOUVER (CA)

(72) Inventor: JOSEPH NILO SARMIENTO, VANCOUVER (CA)

(21) Appl. No.: 14/157,798

(22) Filed: Jan. 17, 2014

(51) Int. Cl. B64B 1/24; B64B 1/36; B64B 1/10; B64B 1/58; B64B 1/70; B64B 1/66; B64B 1/68; B64B 1/02; B64B 1/20

(52) U.S. Cl. CPC B64B 1/24; B64B 1/02; B64B 1/36; B64B 1/10; B64B 1/20; B64B 1/70; B64B 1/66; B64B 1/68; B64B 1/58

(57) ABSTRACT

A highly maneuverable craft or airship with aerostatic lift which may be manned or operated autonomously and remotely consists, in particular, a sail or similar device for main propulsion; the aerostat or dirigible sustains lift from gasbags containing helium or hydrogen or other similar lighter-than-air gas. Further, said aerostat may be mounted with a wind turbine for electrical power generation and mechanical operation; and, ballast tanks and landing gear to enable amphibious capability.

### APPLICATIONS

The present invention claims priority to U.S. provisional application Ser. No. 61/754,526, filed on Jan. 18, 2013, the contents of which are incorporated by reference in their entirety herein.

### FIELD OF THE INVENTION

The present invention relates to a highly maneuverable craft with aerostatic lift, that is, a craft which derives lift from a gas lighter than the mixed atmospheric gases surrounding said craft and herein to be referred to as an aerostat or or airship or dirigible, all meaning to be one and the same.

### BACKGROUND OF THE INVENTION

More particularly, the invention concerns an airship that operates with low noise levels, minimal ecological impact either direct or incident due to a reduced or almost nil exhaust emissions leaving close to a zero carbon footprint while operating, excellent mooring and surface handling characteristics, and it is an amphibious dirigible able to land either on water or land.

Many of the design characteristics, more specifically of propulsion, maneuvering and ground handling of aerostats or dirigibles currently in use have not changed much greatly since the first manned flight of a hydrogen balloon took place on Dec. 1, 1783. Structurally, then as now, a non-rigid envelope of certain flexible material is filled with a gas such as helium or hydrogen or any number of lighter-than-air gas in order to offset all, or substantially all of the weight of the air vehicle, including its own mass, cargo, crew and passengers.

In reference to the propulsion aspect, even when the first manned balloon lifted up to the sky, it became soon apparent for the dire need to direct its flight. Some tried to flap attached bird-like wings and similar contraptions while yet other pioneer aeronauts, like Jean-Pierre Francois Blanchard, tried to use huge oars as when he attempted for the first time to cross the English Channel by air. Then in 1852 a special steam-engine driving a propeller was developed by Henri Giffard and mounted below a 144-foot long elongated balloon. Eventhough its paltry top speed of six miles per hour was not enough to fight against the light breeze that was blowing Giffard nonetheless was able to steer the ship in large circles, the event by itself signalling the first true demonstration of man's first powered flight.

The steam engine soon gave way to the internal combustion engine which was used for the first time aboard an airship in 1871. The fuel for the engine was coal gas, the same that burned in Paris' streetlights, and was drawn directly from the gasbag. It was not long before the internal combustion engine industry followed through on more requirements from later brave, intrepid aeronauts for more powerful engines to carry aboard the airships. Representative of this marriage of late 19th century industrial engineering and ballooning, a twelve horsepower diesel-fed Daimler-Benz internal combustion engine helped propel an airship constructed by Alberto Santos-Dumont and won him the Deutch Prize in Jul. 13, 1901.

Around the time Santos-Dumont was experimenting with his one-man airships in France, at another part of the European mainland in Germany, Count Ferdinand von Zeppelin was already designing and constructing on what was to be the basis of future rigid airship designs. The propulsion means of his first airship, the LZ-1, which first took off in Jul. 2, 1900 from Lake Constance near Friedrichshafen, Germany was provided with two fifteen-hp internal-combustion engines from the same Daimler-Benz company. But it was the British who eventually made the first trans-Atlantic crossing by an airship in Jul. 2, 1919; 108 hours for the east-to-west leg and only 75 hours on the return trip. The airplane would not duplicate this feat until years later in 1928. The R.34, its design reversed engineered from a captured German naval Zeppelin that crashlanded on English soil, was mounted with five gasoline-fed powerplants manufactured by an English company, each engine providing 275 hp. Similar gasoline-fed internal combustion engines providing a total thrust of 2,150 horsepower at normal cruising speed eventually allowed the German airship “Graf Zeppelin” in Oct. 11, 1928 to makes its own successful trans-Atlantic flight, its first of many crossings as it continued to operate commercially from 1928 to 1937; that is, until the Hindenburg fiery crash. The Graf was actually on its way home from Rio de Janeiro in Brazil when the crew received word by radio about the incident. Upon its landing in Germany, the airship was grounded until the cause of the crash was determined. No Zeppelin thereafter ever made another commercial flight.

It is a commonly held belief that the fiery crash of the Hindenburg in 1937 signaled the end of the airship's useful application. In fact, more dirigibles using this time helium for lift but still using internal-combustion engines for propulsion were in the air by the end of the Second World War than at any time in its history serving on surveillance sorties and convoy escort duties. After the war, the U.S. military continued on with its own airship programs under the K-ship program until the last flight by airship K-43 on Mar. 19, 1959.

Since that time however the prior Art has had only limited or almost non-existent practical applications in the world at large and as such has not caused due need to provide funding towards new research and development in the Art. As a representative of the state of the prior Art, the Goodyear blimps, all four remaining sister ships that are still operating, are still of the same design circa 1901 but have gamely gone on trying to become useful even if that use has just been for all intents and purposes as a flying billboard.

But that era may soon be closing and a new one may be heralding itself in. As in the case with the German zeppelins of the previous century, the modern military is again taking a renewed interest in the aerostat. At the forefront of this potential reawakening, is the recent purchase by the United States Army of a fleet of airships called the Airlander, co-manufactured by Britain's Hybrid Air Vehicles and the American defence contractor Northrop Grumman and intended for long-range surveillance missions, both manned and unmanned.

Beyond the military, clearly in deference to the issue of climate change, the Airlander is being marketed as a “green” transport solution, ostensibly using far less fuel than conventional aircraft as it is claimed by the company. For example, the unmanned surveillance version of the Airlander is claimed to be designed at being able to remain aloft for 21 weeks on about 18,000 pounds of fuel, far less in comparison to other airborne surveillance platforms. Still, this so-called advance in the prior Art is still using fossil fuels and therefore still has a definite, large carbon footprint and once assigned to fill various commercial applications, would still expand wider that footprint. Even if an airship's on-board propulsion where to switch to natural gas, nowadays considered as a cheaper alternative to diesel or gasoline, its primary extraction process called fracting has been meet with extreme controversy due to its hugely direct environmental impact and inherent dangers. A design proposal to use hydrogen as fuel in the future of the prior Art would carry with it the same inherent weakness as to why the hydrogen economy has not taken off as promised: it's still prohibitively expensive to extract hydrogen fuel intended for wide-scale usage, both militarily and commercially.

Certainly, the Airlander was just one of many proposed by several top competitors, including Lockheed Martin's P-971 which took second place, when the US Army was looking for new surveillance craft but as representatives of the current practice of the Art, none of these show any advancement in methodologies of propulsion and manuevering means nor in airship mooring and handling.

For the mooring and handling aspects, the current Art practices a type of air cushion landing system which deploys an inflatable cushion to soften landings and provide a suction effect to hold the craft still during loading and unloading. What this means, however, is that the suction mechanism must be operated at all times which in turn calls for further consumption of fossil fuels. And when dealing with the kind of tonnage that an airship can weigh, it would require powerful suction devices and a flat surface under the airship to keep it stable and secured. Another practice of the prior Art to try to resolve the handling issue is by installing an air cushion landing skirt underneath the envelope similar to those employed in hovercrafts that would have allowed it to move and park on its own. But these solutions both suffer from instability issues simply because on the ground as in the air the aerostat may weigh close to nothing but its tonnage would impart with it high momentum once it is subjected to sudden and strong gusts of wind, like any balloon.

Hence, the current practice of the prior ART to use brute force and physical labor to keep an airship close to the ground while attempting to load or unload passengers and cargo therefore reflects no improvements at all towards better mooring techniques since the Art's beginnings in early years of the previous century.

Thus, it is clear that there is a great need in the art for an improved method and system for a clean environment-friendly propulsion and maneuvering means, and for mooring and handling, while avoiding the shortcomings and drawbacks of the prior art apparatus and methodologies heretofore known.

### SUMMARY OF THE INVENTION

The present invention includes many aspects and features. Moreover, while many aspects and features relate to lighter-than-air craft, and are described herein in the context of such devices having aerostatic lift capabilities which utilizes hydrogen or helium or other lighter-than-air gas contained in an envelope to offset or substantially offset the weight of the vehicle and load, the present invention is not just limited to providing a cost-effective, low maintenance, environment-friendly and an almost-nil climate-impact airship operation.

For example, the present invention can be applied to either a manned, unmanned or autonomous aerostat craft that may be tethered to the ground such that it will have the freedom of movement as much as the craft is sailing at a certain altitude but albeit may be holding unto a circumscribed circular flying pattern or a zig-zag course in the sky. This example pertains to the aerostat being utilized either for ground surveillance, weather observations and power generation wherein it may become paramount to limit where and how high the lighter-than-air craft may travel. While untethered, the present invention may also allow a craft to be applied with autonomous control in performing the same surveillance missions, scientific observations not just on Earth but also off-Earth such as the study of the other planets like Mars and Jupiter while cruising within their respective atmospheres.

Accordingly, it is a primary object of the present invention to provide an improved system of propulsion and power generation for aerostats, that may be comparably very cost effective, very environment friendly and may provide zero or almost-nil exhaust emissions while operating. Harnessing the wind has always been an ancient engineering tradition trying to solve similarly age-old problems of proper water irrigation or food processing as in wheat grinding to create flour for bread. At one time, wind power was the only way to get around to and from the New World and when the routes were all well and plotted, it still took months of travel to cross the Atlantic and the other oceans. Nowadays, those twenty-five knot gusts which could sweep across the Pacific now gets the undivided attention of the kiteboarders one may see flinging into the sky as seen from the beaches in Tofino on Vancouver Island. On the land however sometimes the wind blows weakly and sometimes not at all but starting at an altitude of about 1300 feet, close to the height of the Eiffel Tower, the wind actually blows more consistently and usually at one and a half to three times faster that at the earth's surface. The present invention may then allow a craft to be appropriately so equipped with any rigid, substantially vertical airfoil-device or a flexible generally-shaped sail or similar device which may then be deployed at cruising altitude to catch the wind, navigate, manouever and in so doing may provide an environment-friendly, cost-effective method of moving an aerostat from place to place.

Further, it is an object of the present invention in that it may have onboard a device to harness the same wind to generate and further store generated electrical power further allowing said present invention to be independent of any land-based power grid with which to power any of its on-board electronic and electromechanical devices. It may even allow said invention to sell any excess power that may be stored on on-board batteries back to said power-grid.

Another object of the present invention is to provide an improved craft which does not rely on aerodynamics to achieve lift nor to stay aloft, and which possesses a greater ease of manoeuverability even while at close to zero speed or at station keeping, that may be due to the presence of thrusters on gimbals allowing much freedom of movement of said thrusters along three axes namely: lateral, the vertical and the horizontal; which may then also allow for the craft of the present invention to be able to rotate about a substantially vertical axis passing through a center of the air craft. In comparison, traditional and current lighter-than-air craft rely on continuous flow of air across an aerodynamic body and control surfaces to remain aloft and to manoeuver.

And yet another object of the present invention is to provide an improved craft which does not rely on traditional mooring facilities nor the brute physical assistance of extensive ground crews. This is because the present invention may provide the craft an amphibious capability in that it is able to either traditionally touchdown on land, or near the seashore, or on any land-locked body of water such as a lake. The present invention may allow a craft to also contain but is not limited to having hollow ballast compartments within the hull of said craft that may fill with water to serve as ballast, and thus negate the need for any ballast exchange. If once landed on any body of water, for example, the vehicle may be made to be propelled by marine means towards a standard docking facility or port built usually to service water-going ships. Further, such other conventional lighter-than-air vehicles are typically moored at the bow to have to be able to swivel a full 360 degrees in response to wind direction, and as such will need a very large landing pad. The take-off from a water dock of the craft such as described in all the embodiments of the present invention may only require said vehicle to purge the water out of the ballast tanks, raise vertically and navigate towards the desired direction.

This said aspect of the present invention may actually be of great benefit and serve as a safe, affordable, cost-effective, low-maintenance medium of transportation for foot traffic that does not suffer from infrequent trip schedules and thus may pave a new way to better connect the various island communities such as those that similarly may be found in the Gulf Islands and the Sunshine Coast located in the province of British Columbia, Canada. These and similar geographical areas have also been found to have mild weather almost the whole year through most especially the waters between Taxada Island and the mentioned Sunshine Coast. And beyond engendering a new form of sport and toy device, the present invention may even allow such craft to promote further the exploration and a noise-free eco-tourism showcasing the natural resources to be found on the coast or in the interior of a territory whereby automatically eliminating the need to have invasive infrastructure like roads, airstrips or bridges.

The novel features which are believed to be characteristic of the invention, both but not limited to its organization and method of operation, together with further objects and advantages thereof, will be better understood from the following description in connection with the accompanying drawings in which the presently preferred and other embodiments of the invention is illustrated by way of example. It is to be expressly understood, however, that the drawings are for purposes of illustration and description only and are not intended as a definition of the limits of the invention.

### BRIEF DESCRIPTION OF THE DRAWINGS

These and other aspects, features and advantages of this novel sail-equipped amphibious, highly manoeuvrable craft with aerostatic lift will be more easily understood upon consideration of the following detailed description, which refers to an illustrative and preferred but non-restrictive embodiments of the present invention, and from the attached drawings, in which:

FIG. 1 is a top view of the highly manoeuvrable craft with aerostatic lift, equipped with a sail device for propulsion and with some amphibious capability, according to the first embodiment of the present invention.

FIG. 2 is a front view of the amphibious, sail-equipped aerostat of FIG. 1.

FIG. 3 is a perspective view of the amphibious, sail-equipped aerostat of FIG. 1.

FIG. 4 is a bottom view of the amphibious, sail-equipped aerostat of FIG. 1.

FIG. 5 is an interior view of the wind-turbine, sail-pod assembly affixed on an outrigger of the aerostat of FIG. 1.

FIG. 6 is an expanded view of the wind-turbine, sail-pod assembly of FIG. 5.

FIG. 7 is a side view of a sail-pod wheel assembly.

FIG. 8 is an exploded view of the sail-pod wheel assembly of FIG. 7.

FIG. 9 is a close-up view of the sail-mast-boom mount support.

FIG. 10 is an cross-sectional, interior view of the mast support of FIG. 9.

FIG. 11 is a perspective view of the boom stowage compartment with the cover open indicating the placement of the retractable boom.

FIG. 12 is a view of stowage compartment of FIG. 11 with the retractable boom deployed.

FIG. 13 is a perspective view of an outrigger of the aerostat of FIG. 1 with the front panel in open position showing the vanes of the windturbine assembly.

FIG. 14 is a perspective view of the wind-turbine assembly and gear-box assembly.

FIG. 15 is a perspective view of the amphibious, sail-equipped aerostat of FIG. 1 in flight mode with the sails rotated and pointing downwards.

FIG. 16 is a bottom view of the amphibious, sail-equipped aerostat of FIG. 1 showing the locations of the water inlet, scoops and ports of the outriggers.

FIG. 17 is a perspective view of an outrigger of aerostat of FIG. 1 showing the inner and outer hulls and the compartments within.

FIG. 18 is a cross-sectional view of an outrigger of FIG. 17 showing the inner and outer hulls.

FIG. 19 is a top view of the aerostat of FIG. 1 showing the forward and aft locations of the maneuvering thrusters.

FIG. 20 is a rear view of the sail-equipped amphibious aerostat of FIG. 1 showing the aft maneuvering thrusters.

FIG. 21 is a perspective view of the maneuvering thrusters of FIG. 20 expanded to show the gear assembly, motor, propeller and gimbal control assembly.

FIG. 22 is a lateral view of the altitude control assembly shown affixed to the bottom of the gas envelope of the aerostat of FIG. 1 showing the even distribution of aerostatic lift.

FIG. 23 is a lateral view of the altitude control assembly of FIG. 22 showing the change in distribution of aerostatic lift as the ballast is positioned towards the rear of the craft.

FIG. 24 is a bottom perspective view of the highly manoeuvrable craft with aerostatic lift, equipped with a sail device for propulsion and with some amphibious capability, according to the second embodiment of the present invention.

FIG. 25 is an expanded view of the aerostatic craft of FIG. 24 showing the wind-turbine assembly, gearbox assembly and transmission.

FIG. 26 is a perspective view of the second embodiment of the aerostat of FIG. 24 showing the rotated-down sail-mast assembly during flight.

### DESCRIPTION OF THE PREFERRED EMBODIMENT

As a preliminary matter, it will be readily understood by one having ordinary skill in the relevant art (“Ordinary Artisan”) that the present invention has broad utility and application. Further, for additional illustrative purposes other embodiments may also be discussed such as to provide a full and enabling disclosure of the present invention. In addition, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more of the embodiments of the present invention is not to be considered nor construed as providing limitations on the scope of patent protection afforded the said present invention, which scope is to be defined by the claims and the equivalents thereof. Likewise, any reading into any claim a limitation found herein that does not explicitly appear in the claim itself cannot be applied to limit the scope of patent protection afforded the present invention.

Thus, for example, any sequences and/or an apparent temporal order of steps of various methods and/or installations that are described herein are merely illustrative, and are not to be construed as limiting or there being a particular order or sequence that the steps or installations have to follow. Hence, any of the steps or methods of installation can be performed non-sequentially and still remain within the scope of the present invention. Accordingly, the intention is that the appended claims rather defines the scope of the patent protection afforded the present invention, and not the descriptions set forth herein.

Additionally, it is important to note that each term used herein refers to concepts and ideas that the Ordinary Artisan would understands to mean such terms to mean based on contextual use of such terms herein. To the extent that the meaning of a term used herein differs from any particular dictionary definition of such term, it is intended that the meaning of the term as understood by the Ordinary Artisan should prevail.

Referring now to the figures in the accompanying Drawings, the illustrative embodiments of the present invention will now be described in great technical detail, wherein like parts are indicated by like reference numbers.

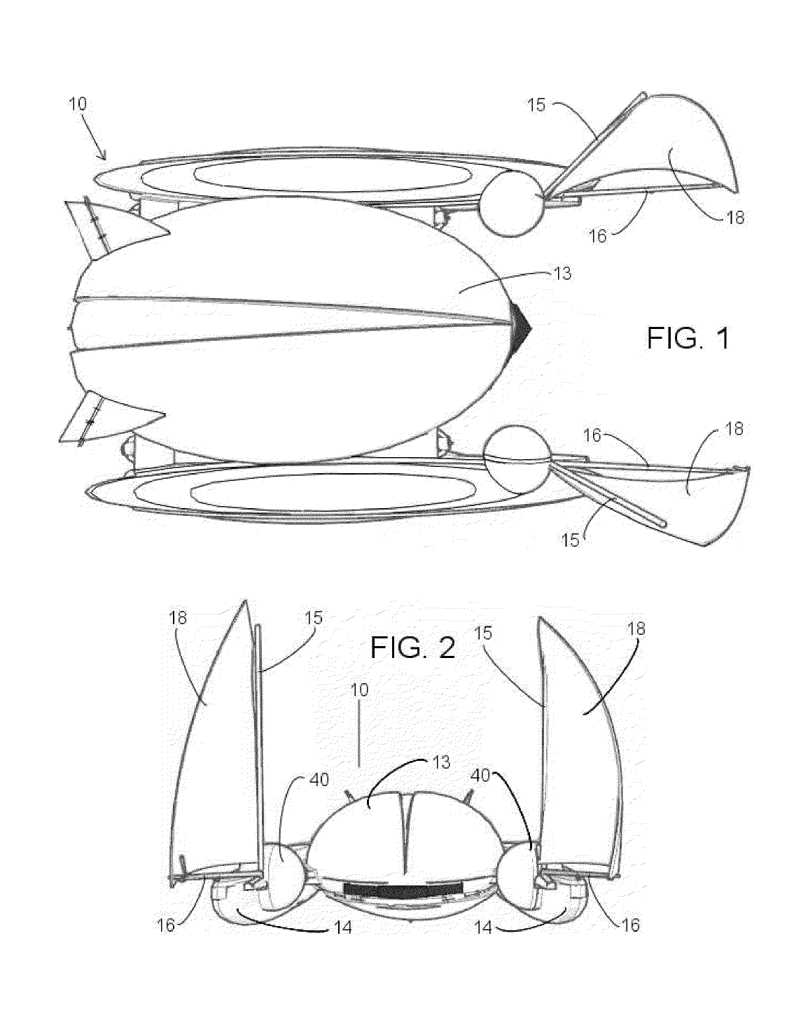

According to one of the broader aspects of the present invention, the first embodiment of a novel sail-equipped aerostat that may include a multiple-hull structure generally referred to by numeral 10 with some amphibious capability and improved maneouverability is shown in various views in FIGS. 1-4.

The aerostat craft 10 shown in FIG. 1 according to the present invention may comprise of a singular or a plurality of lighter-than-air gas-containing bags or envelopes (not shown) contained within a semi-rigid hull structure 13, though to others skilled in the art it may be apparent that the hull may also either be of the non-rigid or the rigid type.

Further, said envelopes may be adapted to contain an aerostatic gas, which, in the preferred embodiment, is helium, though it would be apparent to others skilled in the art that other gases could be utilized singly or in combination (hereinafter, when reference is made to aerostatic or buoyant gas, it is to be understood unless specified that reference is also being made to either hydrogen, helium or its other similar inert lighter-than-air gases up to but not limited to high-temperature gases as would be known to a person skilled in the art).

Still in reference to this first embodiment of the present invention shown in FIG. 2 that purports a craft that may be constructed in the general form of but not limited to a tricatamaran with said craft 10 having a hull assembly comprising but not necessarily limited to a first and second outrigger hulls 14 mounted at the sides of a central hull 13. For purposes of illustration, this and other embodiments of the present invention may show two outrigger hulls 14 as shown but in no manner limits the present invention to the number of outriggers used and configured.

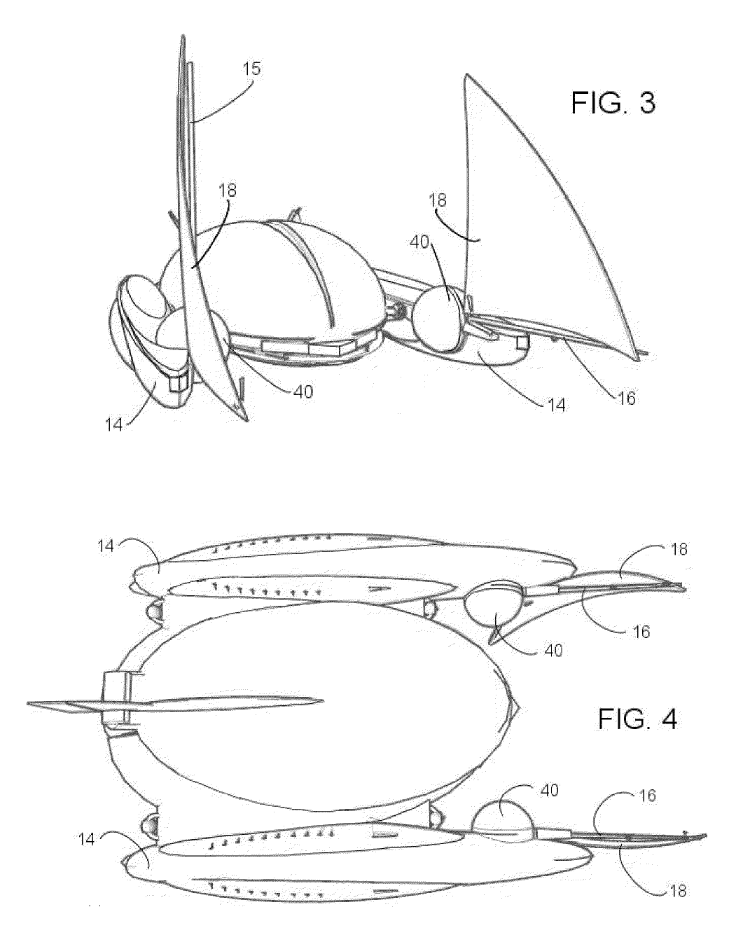

Further shown in FIGS. 2 and 3 which is the frontal and perspective view, respectively, this first embodiment of a generally lighter-than-air amphibious and maneuverable craft has a mast 15 and boom 16 assembly fixedly mounted to a rotatable pod assembly 40 for supporting all of the conventional standing and running rigging (not shown) and either a rigid, substantially vertical airfoil device 18, or a plurality of sails 18 made of a flexible material with a shape that is but not necessarily limited to substantially triangular or trapezoidal, or a combination of the two sail types. For purposes of illustration, a standard sail shape and dimensions are used but hereinafter, when reference is made to a sail, it is to be understood that reference is also being made to similar other types of non-rigid sails and any rigid or semi-rigid airfoil-like device. Also, said sail assemblies are dually mounted on a pair of outriggers 14 attached to the main hull 13.

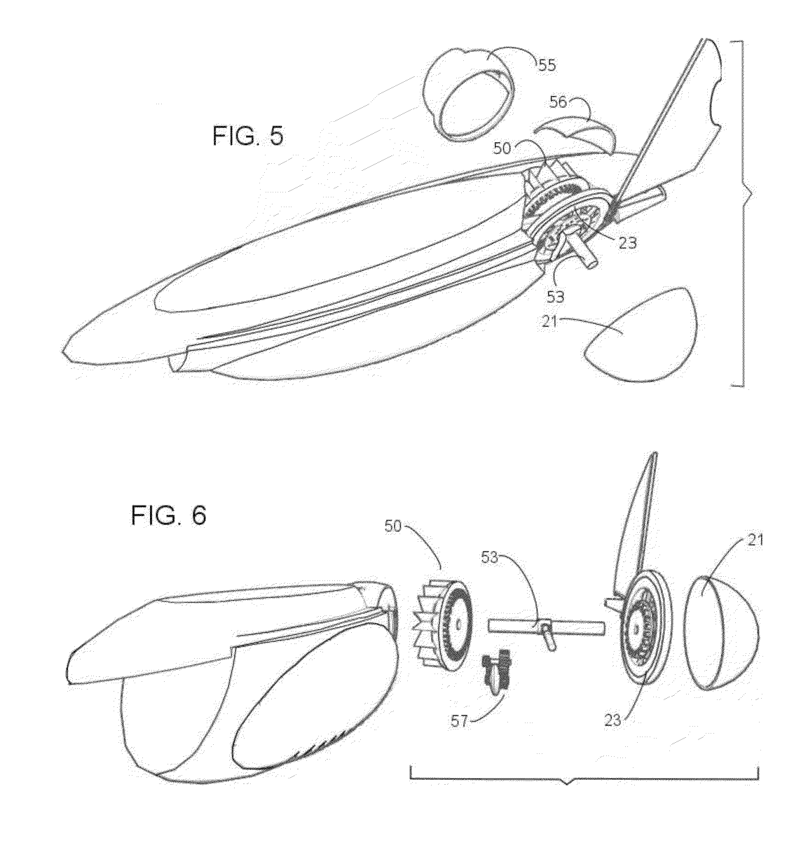

In FIGS. 4 to 14 are shown an aspect of the preferred embodiment that teaches more in detail one method that a sail may be mounted to a generally lighter-than-air amphibious and maneuverable aerostat but in no manner limits the embodiments or aspects of the present invention. Thus, in FIG. 4 which is a bottom view of the craft a semi-spherical sail pod assembly 40 that is freely-rotating laterally on its horizontal axis is constructed forward on the hull of each outrigger 14 such that it also extends out on the side facing the other outrigger hull but made to be above the waterline of the craft where it to be landed on a body of water. As seen partly in the interior view of the forward section of an outrigger hull and expanded views shown in FIGS. 5 and 6, respectively, the sail pod assembly further comprises a mast-support wheel assembly 23, a protective semi-spherical shell 21 covering and affixed movingly to said wheel assembly, a wind turbine assembly 50 with an esconching semi-spherical shell 55 affixed permanently on the top deck of the outrigger over said turbine assembly as protection, said turbine assembly cover further having a sliding curved convex panel 56 for windflow control means to the turbine sections, the moving means to open and close the panel (not shown) and a rotor shaft 53 which is affixed and supported on the outrigger interior hull. The positional mounting of the various assemblies, rotor shaft 53 and the gearbox assembly 57 is further shown in an expanded view of the sail pod assembly in FIG. 6.

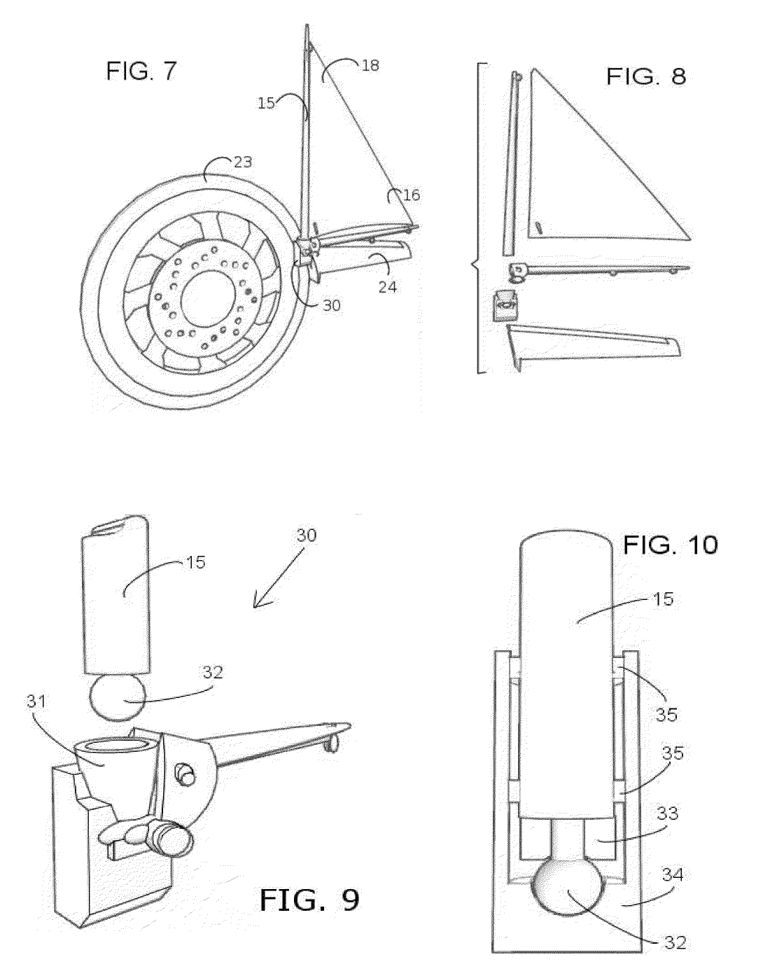

Further, as seen in FIG. 7, retractable boom stowage compartment 24, the mast 15, boom 16 and sail 18 assembly are connectively affixed to a mast mounting and bushing hardware 30 located latitudinally on the circumference of the wheel assembly 23 so that upon rotational movement around the horizontal axis of the sail pod as hereinafter further described, said entire sail pod assembly, including the mast , boom and its adjoining stowage compartment, sails, and all rigging (not shown), may be rotationally moved laterally around same horizontal axis. FIG. 8 shows an expanded view illustrating the positional mounting of the sail-mast-boom assembly.

FIG. 9-10 further shows in some detail how the mast-mounting support assembly 30 may be constructed but in no manner limits and restricts the embodiment of the present invention. Said assembly may be latitudinally located on the rim of the wheel, with said wheel to have a diameter that may allow enclosure with by the semi-spherical cover, the mast mounting and bushing hardware 30 is affixed as shown having also a mast socket 31 of certain depth and an opening which matches the outside diameter of the mast 15. Further, referring to FIG. 10 which is a cross-sectional view of the mast socket, a tow ball 32 of certain diameter may be affixed permanently to the base 33 of the mast and subsequently resting securely on a socket assembly 34 affixed to the bottom of the shaft, said base 33 further having a recess to accept the ball as shown. Also, a bearing or bushing 35 sits inside the shaft hole in the top and the bottom to support and allow the mast to rotate freely around its vertical axis.

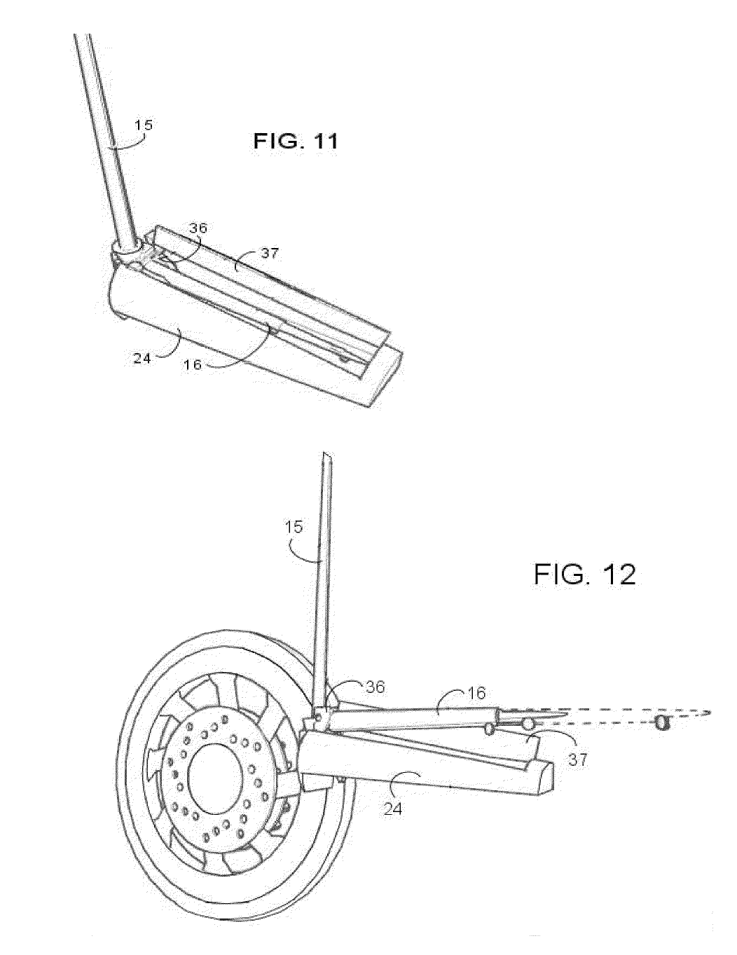

Still in reference to mounting sails on a generally lighter-than-air amphibious and maneuverable craft, FIGS. 11-12 is shown how the present invention may further use a telescoping boom 16 to support said sail device but in no manner limits or restricts the present embodiment of the present invention. FIG. 11 shows the fixed boom section 16 with the telescoping section retracted and the sail stowed in its compartment 24 affixed with a hinged cover 37 when not in use. The means to deploy the sail is provided by a remotely operated lever arm-cable assembly 36 and moves the boom 16 and sail device (not shown) to deploy out of stowage and then latch on to the mast 15 as next seen in FIG. 12. Further, the means to extend the telescoping section of the boom to its full extension is provided by a rack and pinion assembly (not shown) while a gear-and-pully assembly (not shown) also operated remotely will provide the means to move the halyard to raise the sail.

However, proper operation of the sail may require that the sail assemblies to be preferably not in the same plane as the gas envelope or the hull. One aspect of the present invention allows the craft while in flight to sail against the wind in a technique called tacking, a practice used by water borne vessels. In sailing, usually the downward-acting force representing the weight of a regular water sailing craft is countered by the buoyancy force of the water with the upward resulting force acting from a point along where waterline meets the hull of the craft. The forces acting on the sail, the sailboat's keel and its ballast is samely applied at that same point and it is the resultant vectors of those forces that allows the sailboat to move forward even against the flow of the wind. However, for an aerostat, the source providing the the buoyant force or effect is located above the fuselage or gondola and thus the need to relocate the sail to the plane beneath the centerline of the aerostat, opposite from the buoyant force.

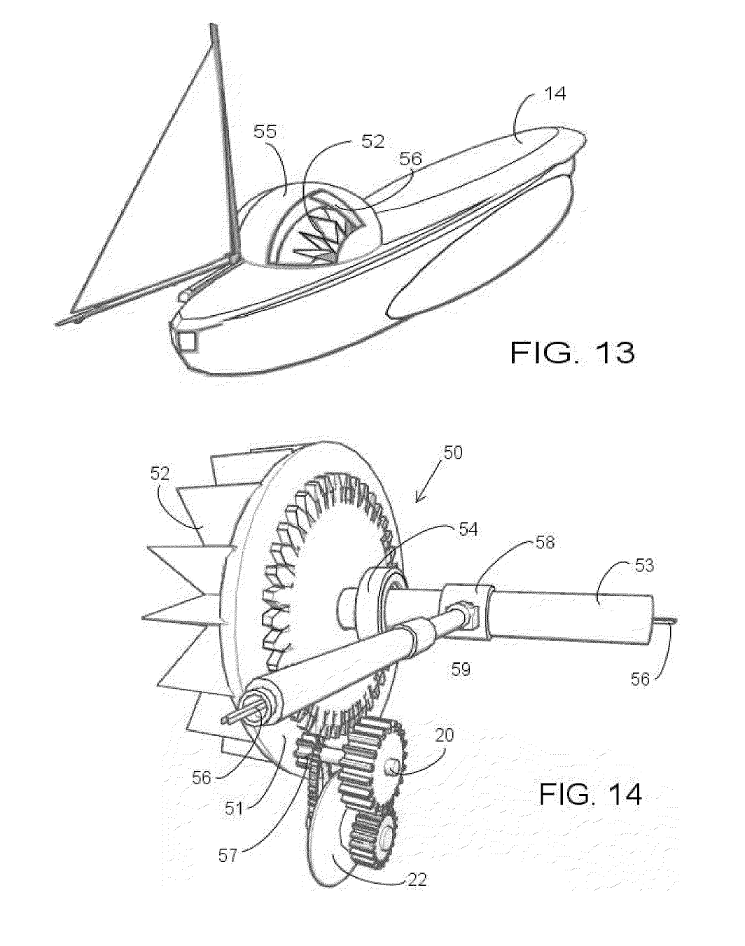

Means are thus provided to move the sail pod assembly 40 as seen in FIG. 5 and rotate it by as much as 180 degrees laterally around its horizontal axis that afterwards the mast is generally pointing substantially down planetward. This moving means which in no manner limits the aspects of the embodiment of the present invention is best illustrated now in FIGS. 13 and 14.

As seen in FIG. 13, the turbine vanes 52 of certain widths and dimensions are made to extend at a certain distance out of the top deck of the outrigger hull 14 and as such are further protected partly overhead by an esconching semi-spherical shell 55 and a sliding curved convex panel 56 facing forward. With said curved convex panel having been caused to slide open remotely, the wind currents flowing across the outrigger deck while the craft is cruising at altitude are to impact the vanes 52 causing the wind turbine to rotate.

As seen now in FIG. 14, said wind turbine assembly 50, in turn further comprises a freely rotating paddlewheel 51 that is supported on one end by a bearing 54 affixed to the outrigger hull (not shown) and drivingly connected to the rotor shaft 53, and a gearbox assembly 57 connecting said paddlewheel 51 to the the mast-support wheel assembly. Further, said gearbox assembly 57 may be comprised of a flywheel 22, a plurality of differentials (not shown) and a low-speed, high-torque gear assembly 20 that is drivingly connected to the mast-support wheel assembly 23 (shown in FIG. 6).

Thus, wind currents flowing across the outrigger deck are to impact the vanes 52 causing the paddlewheel assembly to rotate driving the high-speed rotor shaft and a gear box assembly 57 comprises a plurality of differentials that may controllably transfer some or all of this rotational energy through a clutch (not shown) or a functionally similar device into the low-speed high-torque gear box 20 that is drivingly connected to the sail wheel assembly, or to a flywheel 22. The flywheel 22 may be used to store all of the excess or unused rotational energy resulting from the operation of the wind turbine 50 for later use such as when the wind current is flowing of such strength as not to be able to drivingly rotate the paddlewheel 51, in which case a differential in the gear box assembly 57 will drivingly connect the flywheel to the high-torque gearbox 20 to rotate the same sail wheel assembly.

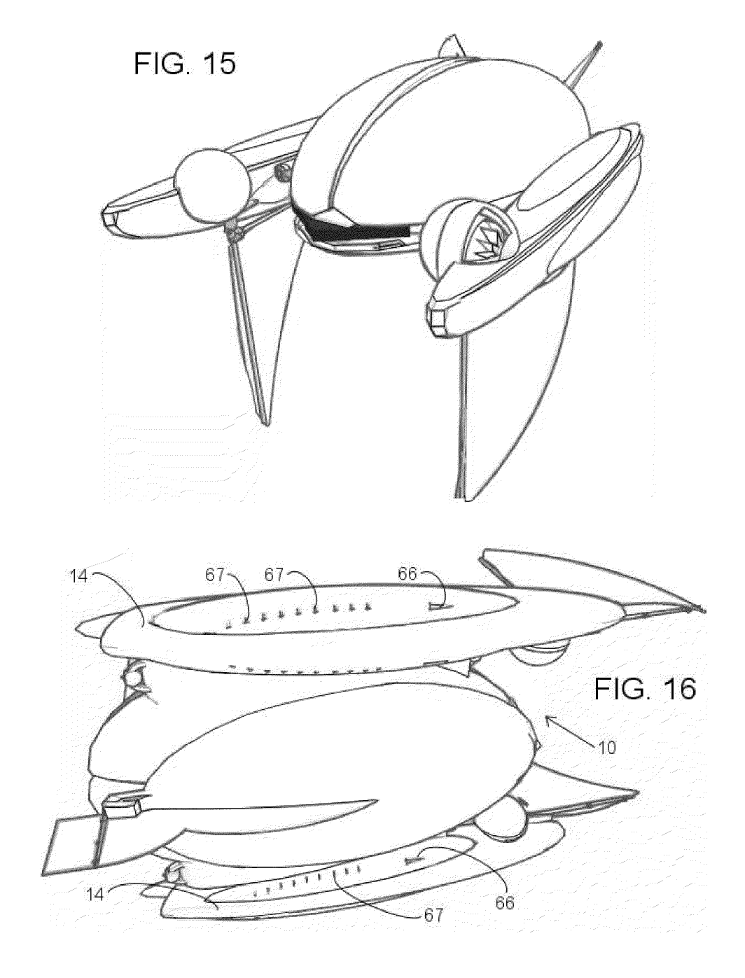

Further, a transmission 59 also drivingly connected to the rotor shaft 53 through a differential 58 or a functionally similar device may further allow torque to be redirected tangentially to the outrigger's or craft's hull to operate electromechanical devices, electric generators and run any of the various gear assemblies of the craft's outside control surfaces. Further still, cable assembly 56 may be embedded in the interior of said transmission as control means for the sail rigging. In FIG. 15 is now shown the craft of the preferred embodiment with the sail assembly full rotated downwards and during flight mode.

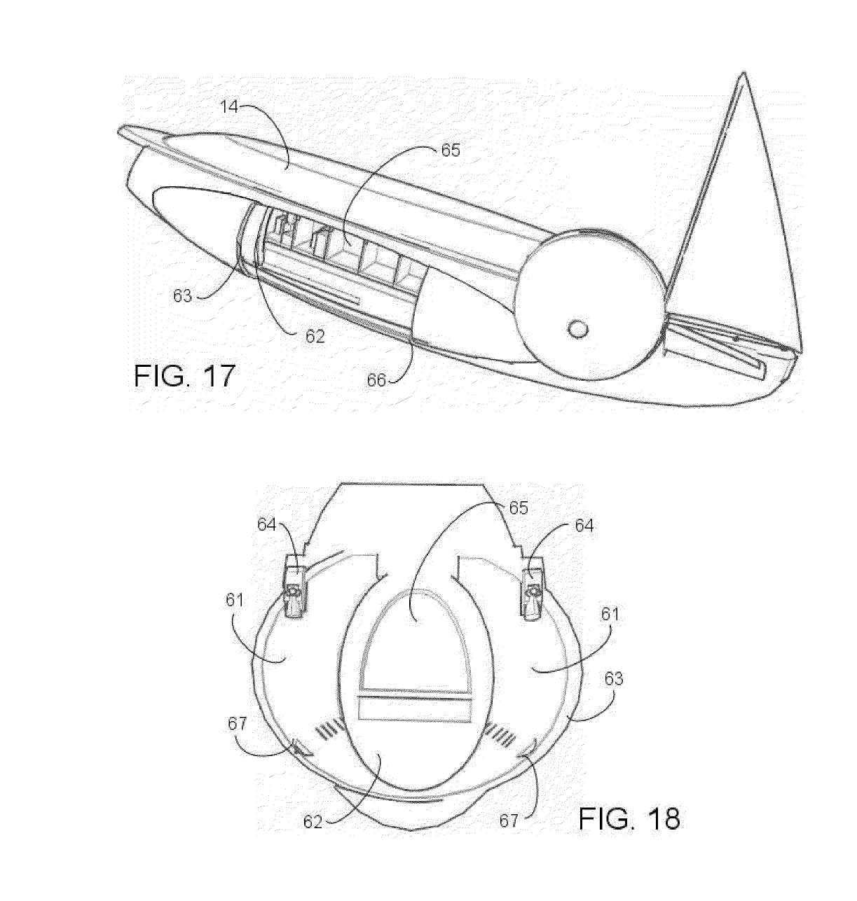

In FIG. 16 is shown another aspect of the preferred embodiment of the present invention showing a bottom view of the craft 10 illustrating forward openings or scoops 66 provided in the outrigger hull 14. Similar openings or valves 67 are further provided in parallel along the bottom of said hull but below a projected waterline (dotted line) with the openings preferably large enough such as to assure that the water or similar liquid may freely enter the hollow spaces or chambers between the inner 62 and outer hulls 63 and similarly permit draining. Means in the outrigger allow the openings to be controllably released such that the plurality of valves 67 and scoops 66 being in fluid communication with the water ballast tanks 61 shown in FIG. 17 may controllably take in water or equivalent liquid and flood said ballast tanks when said craft is landing on a body of water to serve as ballast means.

Further, this aspect of the preferred embodiment of a novel sail-equipped aerostat that may include a multiple-hull structure with some amphibious capability and improved maneouverability is shown in various views in FIGS. 17-18 having a single or a plurality of sealed ballast tanks located between an inner hull 62 and an outer hull 63. With air valves 64 or similar devices located along the upper surface of the outer hull 63 having been released open upon landing on a body of water such as a lake, river or sea, the craft may controllably release the plurality of water valves 67 allowing water or similar liquid to flood into a single or a plurality of sealed ballast tanks 61 thus serving as ballast in the manner of the existing art of submersibles. With the ballast tanks substantially filled with water or similar liquid, the weight of the aerostat substantially increases until it equalizes or surpasses the buoyant force presented by the aerostatic gas further allowing the outriggers to controllably sink in tandem to a determined depth thus stabilizing substantially further the craft. This aspect of the present invention teaches without purging or exiting substantially amounts of aerostatic gas, the aerostat may now be further operated and promote an ease of handling as a water-borne craft. Further, as seen in FIGS. 17 and 18, said outrigger hull may contain air-tight chambers 65 in the inner hull 62 for cargo and living quarters.

Still further, in reference to FIG. 18, when the aerostat requires to lift from the surface, the controllable air valves 64 or devices of similar function are closed and an air compressor (not shown) may be operated to pump pressurized air or similar gas into the ballast chambers. Air pressure will substantially increase and exceed the outside water pressure forcing water out of the ballast tanks 61 that are in fluid communication with a plurality of valves 67 whereby once more making the aerostatic or buoyant force be dominant against the weight of the craft, lifting said craft. While in flight said openings 67 and 66 are subsequently closed.

Another aspect of the sail-equipped aerostat with some amphibious capability and improved maneouverability having a wheel well (not shown) in the bottom of said outrigger hull, a wheel or landing skids for landing the craft on a runway, and apparatus for raising the wheel or landing skids into the wheel well and for lowering it for landing.

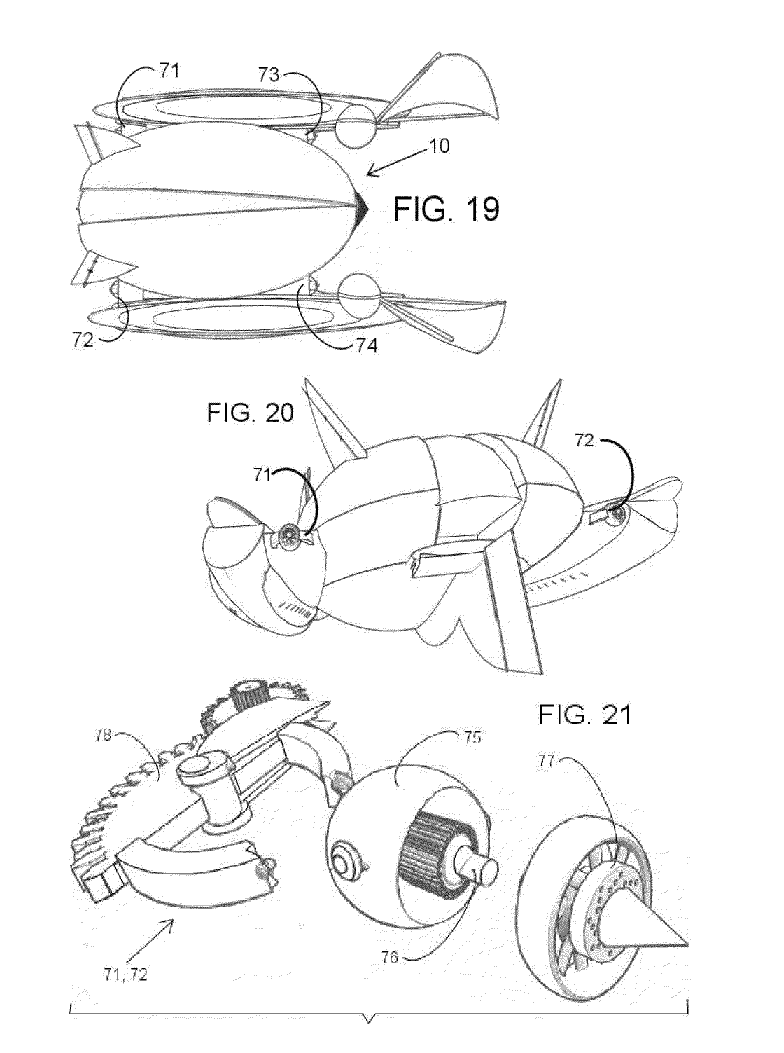

In another aspect of preferred embodiment of the present invention of a aerostatic craft equipped with a sail and with some amphibious capability having limited or nil aerodynamic control surfaces, the craft has the maneauvering means suitable to substantially affect orientation of the craft 10 along its pitch and yaw axis and that may further allow the craft to remain at station keeping. As seen in FIGS. 19 and 20 which is a top view and rear view of the craft, respectively, the maneouverability means comprises but does not necessarily limit the preferred embodiment of the present invention a plurality of gimbaled thrusters 71, 72, 73, and 74 located but not necessarily limited to locations of the hull as indicated. Referring to FIG. 20, gimbaled thruster means 71 and 72 are generally facing aft and affixed to the hull at a point equidistant from the craft's centerline and having the motor means can rotationally incline and decline its angle such that the output thrust may be directed substantially 90 degrees above and below the horizontal plane, respectively. Further, said thruster means having the motor means can movingly rotate around on its vertical axis by substantially 140 degrees. Any thruster means co-located and substantially facing forward of the craft may operate similarly.

Further shown in expanded view, FIG. 21 teaches how the thruster means may be constructed but does not necessarily limit the aspects of the embodiment of the present invention. As indicated, said thrust means comprises a rotor shaft 76 that drivingly connects a propeller means 77 to a gimbaled electro-mechanical motor assembly 75 and a motor gimbal control assembly 78.

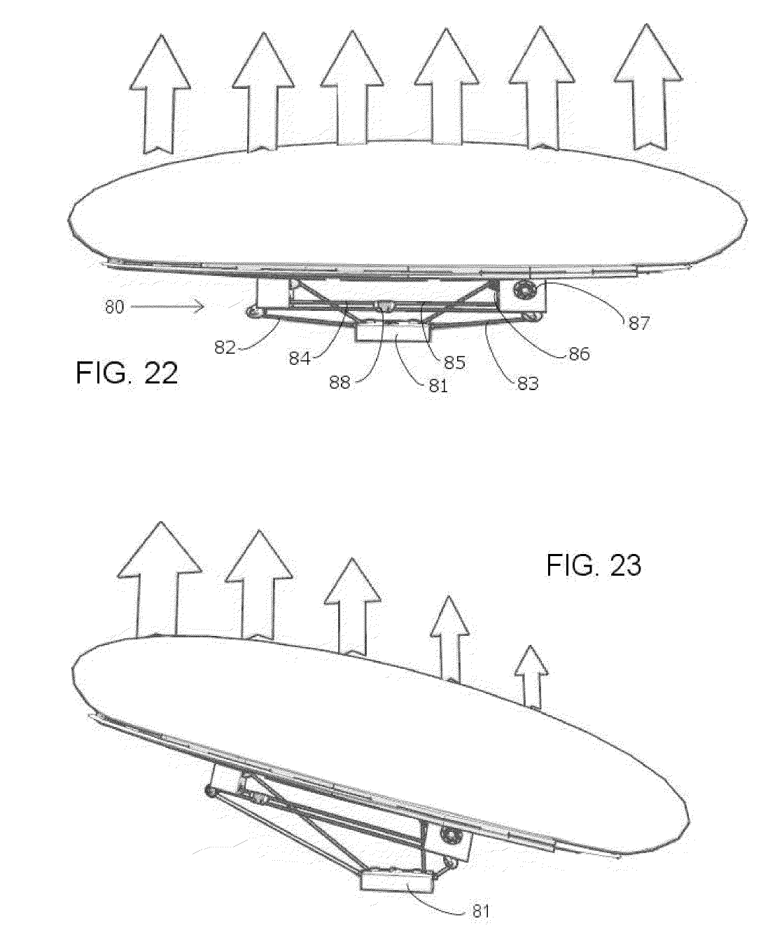

In FIGS. 22-23 is shown another aspect of preferred embodiment of the present invention of a aerostatic craft equipped with a sail device and with some amphibious capability and having limited or nil aerodynamic control surfaces has the means to increase or decrease the altitude of said craft but does not in any manner limit the embodiments of the present invention. As seen in FIG. 22, said altitude control means 80 may be constructed to comprise a certain load or mass 81 connectedly suspended between two load-bearing cables means 82 and 83, guide cables means 84 and 85, a metal clasp 88 which collectively links the two cable means, pulley-gear assembly 86 and a winch 87.

The winch may be operated manually or drivingly connected to a gear box (not shown) such that the clockwise or counterclockwise rotation of said winch 87 moves the gear-pully assembly 86 which in turn drivingly pulls in either direction the guide cables 84 and 85 to resultantly pull the ballast 81 forward to the bow or towards the rear of said craft, respectively. As the guide cable and load-bearing cables are collectively connected by clasp 88 both cable means may resultantly move in tandem and towards same direction, controllably moving the ballast 81 and in like manner has the effect of repositioning the craft's center of gravity . Thus, similar to the manner that a see-saw may tilt downwards at one end towards which one of the riders may be moving closer to, moving the ballast further to the aft may correspondingly relocate the center of gravity samely in the same direction, enabling the rear sections to become heavier, tilting same rear section downwards. This also has the effect of having the buoyant gas in the rear to rush and accumulate in the forward sections, substantially producing more lift effects and increased pitch.

As seen in FIG. 23, the bow or the nose of the craft is now higher than the aft section. When the required altitude has been achieved, the winch may be pulled and rotated oppositely whereby the ballast will be movingly be repositioned forward, substantially leveling the vessel again. Similar operation may be followed to affect a decrease in altitude in which the ballast 81 is repositioned forward.

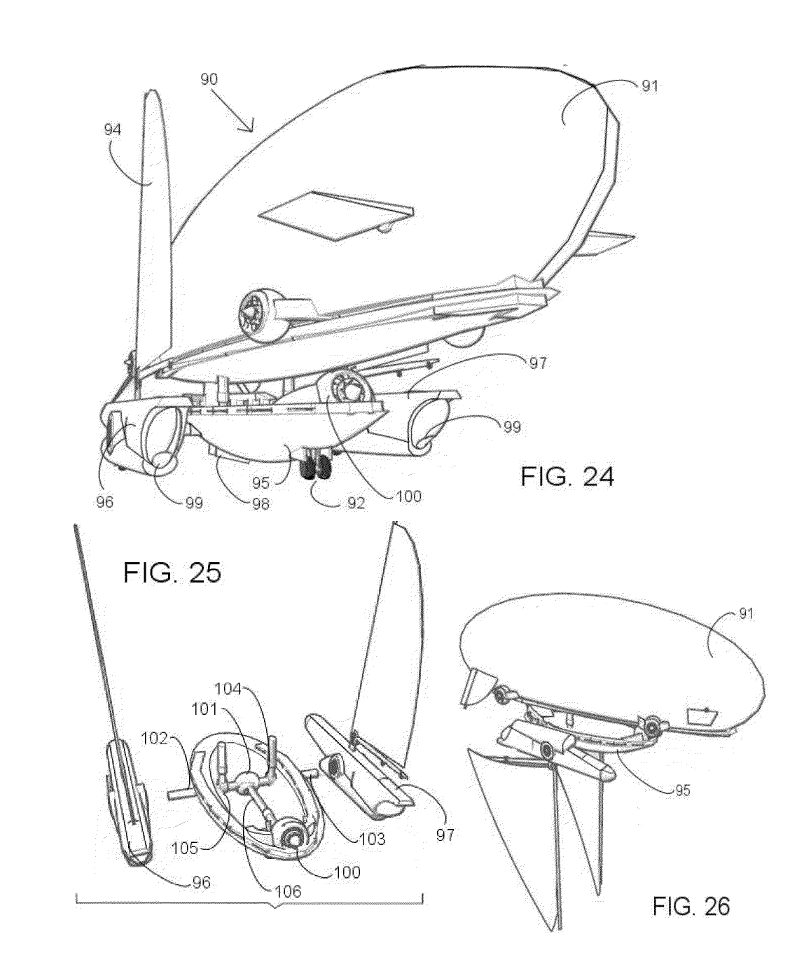

FIGS. 24-26 shows another embodiment of the present invention of an aerostat that may be equipped with a sail for propulsion that may include a multiple-hull structure with some amphibious capability and improved maneouverability, wherein the mast-sail assembly is affixed on outriggers that are free to controllably rotate. FIG. 24 further shows a perspective view of said second embodiment having a gondola or fuselage 95 housing a deck for either a manned control station or set up for autonomous control being hangingly semi-detached from either a rigid or semi-rigid or nin-rigid gas envelope 91 containing the aerostatic gas elements, said fuselage 95 being connected to the gas envelope structure via a plurality of support cables (not shown) or stanchion masts, a wind turbine assembly 100 located at the bow. Further, said embodiment may have a singular or a plurality of outriggers 96 and 97 connectively attached to the sides of said fuselage 95, said outriggers similarly equipped with a wheel 92 and wheel well (not shown) for landing on land, having a mast and boom support assembly 94 and rigging (not shown) fixedly mounted to the top deck of the outrigger 96 and 97, a keel-rudder device 98, a singular or plurality of hollow compartments or tanks (not shown) for ballast means , an electrical airpump means (not shown) that can force pressurized air or similar gas into said ballast tanks, also having an amphibious aspect to similarly effect a landing on any body of water may have forward openings 99 and valves at the bottom of the outrigger that are in fluid communication with the ballast tanks and further said openings having apertures preferably large enough such as to assure that water or similar liquid may feely enter to flood the ballast tanks and similarly permit draining.

Further, said outriggers are made to freely rotate substantially by 180 degrees around its lateral horizontal axis. FIG. 25 shows how the rotational means may be constructed but in no manner limits or restricts the embodiment of the present invention. The said rotational means comprises a wind turbine assembly 100, a drive train assembly 101 which connectively communicates said transmission to the lateral axles 102 and 103 and bearing assemblies 104 and 105. The wind turbine when operating may transfer rotational and torque energy via a gearbox assembly (not shown) to the transmission 106 or at the differential gear of said drive train assembly 101. A clutch of same drive train assembly 101 may then controllably rotate the axles 102 and 103 that are in communication to the outriggers. A bearing or bushing assembly 104 105 affixed to the fuselage further supports said axles which when caused to be rotated by the drive train substantially for 180 degrees, the entire outrigger hulls 96 and 97, mast-sail assembly, and all rigging (not shown), will be moved correspondingly around its lateral horizontal axis. As seen now in FIG. 26, this allows the sail or similar device now inverted operably and with the mast pointing relatively to the ground, to be able to operate clear from any impediments to wind flow such as those presented by the bulk of the gas envelope 91 and the fuselage 95.

What is claimed:

1. an aerostat equipped with a sail or similar air-foil device that may include a multiple-hull structure of a rigid-, semi-rigid, or flexible airframe with some amphibious capability and improved maneouverability, the aerostat or dirigible comprising:
a) gas envelope for containing the aerostatic or lifting gas;
b) a hull that is attached beneath the envelope with at least one or more outriggers one on either side;
c) the outrigger being rotatetable substantially for at least 180 degrees along its vertical axis;
d) rotating means for the outrigger;
e) the main hull and outriggers being floatable for landing the aerostat on water, each outrigger having a plurality of water ballast compartments, a scoop at the forward end of the outrigger hull to take in water to the ballast compartment, and a airpump-valve assembly to discharge the water;
f) platform affixed to outriggers being substantially rotatable for at least 180 degrees along its vertical axis;
g) rotating means for said platforms;
h) propulsion means for said aerostat;
i) a mast, boom, sail and rigging assembly for propulsion means;
j) a plurality of rigid and flexible sails having substantially fixed dimensions and shape rigged to the mast-boom assembly;
k) a plurality of gimbaled thrusters for maneuvering means;
l) said aerostat having a vertical rudder for steering and changing the direction of travel;
m) said aerostat having a ballast system that allows altitude control by means of varying the position of a ballast forward or backward along the length of the aerostat; wherein, the volume of lifting or buoyant gas pumped into the gas envelope will eventually support and offset the total weight of the aerostat bringing the whole system into equilibrium, the variable-position ballast when moved to the rear will raise the bow of the aerostat and moving the ballast forward will correspondingly move the stern of the aerostat to that level with the bow;
n) canards at the leading edges of the envelope and hull for pitch control means;
o) said aerostat having an releasable tether hook located towards the stern, and apparatus for unlocking the hook to release any tether cable.

2. an aerostat equipped with a sail or sail-like device that may include a multiple-hull structure of a rigid-, semi-rigid, or flexible airframe with some amphibious capability and improved maneouverability.
The aerostat further comprising: a. gas envelope for containing the aerostatic or lifting gas; b. a hull that is attached beneath the envelope with at least one or more outriggers one on either side; c. the outrigger being rotatetable substantially for at least 180 degrees along its vertical axis and rotating means for the outrigger; said the hull and outriggers being floatable for landing the aerostat on water, each outrigger having a plurality of water ballast compartments, a scoop and openings on the outside hulls to take in water to the ballast compartment, and pumping means to discharge the water; d. platform affixed to outriggers being substantially rotatable for at least 180 degrees along its vertical axis and the rotating means for said platforms; e. a mast, boom, sail and rigging assembly for propulsion means; said plurality of rigid and flexible sails having substantially fixed dimensions and shape rigged to the mast-boom assembly; e. a plurality of gimbaled thrusters for maneuvering means.

3. The aerostat in claim 2, having a ballast apparatus for altitude control means comprising a ballast weight suspended horizontally by cables, said cables in turn supported on a gear-winch assembly that moves the said ballast weight bi-directionally. Moving said ballast weight towards aft of the aerostat will pitch up the bow of the aerostat as the center of gravity of said aerostat to also shift in the same direction. With the bow section at higher elevation compared to the aft section, the buoyant gas in the rear sections of the gas envelope will rush towards the forward sections producing more lift effect. When the desired altitude has been reached, the winch is counter-rotated moving the ballast weight back to a more central position.

4. The amphibious aerostat according to claim 2, which has a mast, boom and sail assembly for propulsion means;

5. The assembly according to claim 4, wherein the propulsion means further comprises a controllable sail assembly mounted on the deck of each outrigger hull or platform, including a mast collapsably connected to the mast block bolted to outrigger deck or platform, a rigidly vertical airfoil or flexible sail attached to the mast, and a telescoping boom operably connected to the sail.

6. The assembly according to claim 4, wherein the propulsion means also consists of a plurality of rigid and flexible sails having substantially fixed dimensions and shape rigged and attached to the mast-boom assembly;

7. The assembly according to claim 4, wherein the boom comprises multiple boom sections that can extend telescopically with locking latch mechanisms, and apparatus for extending and retracting said boom assembly;

8. An aerostat equipped with a sail or sail-like device that may include a multiple-hull structure of a rigid-, semi-rigid, or flexible airframe with some amphibious capability and improved maneouverability, the aerostat comprising: a. gas envelope for containing the aerostatic or lifting gas; b. a hull that is attached beneath the envelope with at least one or more outriggers one on either side; c. the outrigger being rotatetable substantially for at least 180 degrees along its vertical axis and rotating means for the outrigger; said the hull and outriggers being floatable for landing the aerostat on water, each outrigger having a plurality of water ballast compartments, a scoop and openings on the outside hulls to take in water to the ballast compartment, and pumping means to discharge the water; d. platform affixed to outriggers being substantially rotatable for at least 180 degrees along its vertical axis and the rotating means for said platforms; e. a mast, boom, sail and rigging assembly for propulsion means; said plurality of rigid and flexible sails having substantially fixed dimensions and shape rigged to the mast-boom assembly; e. a plurality of gimbaled thrusters for maneuvering means.

9. The amphibious aerostat according to claim 8, wherein the sail mast-boom assembly and the outrigger and platform can be controllably rotated a substantial 180 degrees from an upright to a downward vertical position, and apparatus for rotating said mast-boom assembly affixed to the outrigger and platforms;

10. The amphibious aerostat according to claim 8, comprising a ballast system assembly that allows altitude control by means of varying the position of the ballast forward or backward along the length of the aerostat, and the apparatus for moving the ballast;

11. The assembly according to 10, wherein the variable-position ballast when moved to the rear will raise the bow of the aerostat and moving the ballast forward will correspondingly move the stern of the aerostat to that level with the bow resulting in an higher altitude;

12. an aerostat equipped with a sail or sail-like device that may include a multiple-hull structure of a rigid-, semi-rigid, or flexible airframe with some amphibious capability and improved maneouverability, the aerostat comprising: a. gas envelope for containing the aerostatic or lifting gas; b. a hull that is attached beneath the envelope with at least one or more outriggers one on either side; c. the outrigger being rotatetable substantially for at least 180 degrees along its vertical axis and rotating means for the outrigger; said the hull and outriggers being floatable for landing the aerostat on water, each outrigger having a plurality of water ballast compartments, a scoop and openings on the outside hulls to take in water to the ballast compartment, and pumping means to discharge the water; d. platform affixed to outriggers being substantially rotatable for at least 180 degrees along its vertical axis and the rotating means for said platforms; e. a mast, boom, sail and rigging assembly for propulsion means; said plurality of rigid and flexible sails having substantially fixed dimensions and shape rigged to the mast-boom assembly; e. a plurality of gimbaled thrusters for maneuvering means.

13. the amphibious aerostat according to claim 12, having a plurality of controllable gimbaled thruster assemblies strategically located on the hull and outriggers for manuevering means;

14. the thruster assembly according to claim 13, comprising: a gimbal control assembly, positioned proximate to the envelope and hull, a pair of gimbals supported on said gimbal control assembly, a powered motor engine attached to said gimbals, and apparatus for directing the orientation of the engine.

15. The thruster assembly according to claim 14, further comprising a powered motor engine attached to the said gimbal assembly and a propeller, said motor engine adapted to rotate said propeller.

16. the amphibious aerostat in claim 12, comprising outrigger hulls having an elongated hull structure, said outrigger having an outer hollow chamber for ballast means, an inner chamber nesting within said outer ballast chamber, said chambers being non-communicating with respect to each other, and said inner chamber further comprising a plurality of compartments for equipment, stowage and living quarters.

17. the outrigger in claim 16, further comprising a water inlet-scoop with a controllable aperture located at the bottom forward end of said outrigger to collect water for ballast when the outrigger or craft is on the surface of a body of water, a plurality of controllable valves located linearly at the bottom of the outrigger hull and communicating to the ballast chamber via pipes to let water ballast out, and apparatus for forcing water ballast from the outer chamber.

18. the amphibious aerostat of claim 12 having one or a plurality of wind turbine devices for charging the on-board batteries and power generation;

19. the amphibious aerostat of claim 12 having a plurality of outrigger hulls each hull having a landing gear.

20. the amphibious aerostat of claim 19 having a wheel well at the bottom of each said outrigger, a wheel for landing the aerostat on a landing strip, and apparatus for raising the wheel into the wheel well and for lowering it for landing.
